(19) United States
(12) Patent Application Publication
(10) Pub. No.: US 2009/0059585 A1
(43) Pub. Date: Mar. 5, 2009

(54) ILLUMINATION SYSTEM

(75) Inventors: S-Wei Chen, Hsinchu (TW); Fu-Ming Chuang, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 12/045,300

(22) Filed: Mar. 10, 2008

(30) Foreign Application Priority Data
Aug. 29, 2007 (TW) 96132000

(51) Int. Cl. F21V 7/00; F21V 11/00

(52) U.S. Cl. 362/235; 362/341; 362/347

(57) ABSTRACT

An illumination system capable of providing at least one light beam to a light valve is provided. The illumination system includes at least one light source, a linearization beam shaper and an optical scanning device. The light source is capable of providing the light beam. The linearization beam shaper is disposed on a transmission path of the light beam and between the light source and the light valve to expand the light beam along a first direction. The optical scanning device is disposed on the transmission path of the light beam and between the linearization beam shaper and the light valve. The optical scanning device is capable of moving for making the light beam scan on the light valve unidirectionally along a second direction or back and forth along the second direction.

### CROSS-REFERENCE TO RELATED APPLICATION

This application claims the priority benefit of Taiwan application serial no. 96132000, filed on Aug. 29, 2007. The entirety of the above-mentioned patent application is hereby incorporated by reference herein and made a part of this specification.

### BACKGROUND OF THE INVENTION

1. Field of the Invention

The present invention relates to an illumination system. More particularly, the present invention relates to a scanning illumination system.

2. Description of Related Art

Referring to FIG. 1, a conventional projection apparatus 100 includes an illumination system 110, a digital micro-mirror device (DMD) 120 and a projection lens 130. The illumination system 110 includes a red light source 112r, a green light source 112g, a blue light source 112b, two dichroic mirrors 114a and 114b, and a light integration rod 116. A red light beam 113r emitted from the red light source 112r is reflected by the dichroic mirror 114b and passes through the light integration rod 116 to reach the DMD 120 in sequence. A green light beam 113g emitted from the green light source 112g passes through the dichroic mirrors 114a and 114b, and passes through the light integration rod 116 to reach the DMD 120 in sequence. A blue light beam 113b emitted from the blue light source 112b is reflected by the dichroic mirror 114a, pass through the dichroic mirror 114b, and pass through the light integration rod 116 to reach the DMD 120 in sequence. The DMD 120 converts the red light beam 113r, the green light beam 113g and the blue light beam 13b into an image beam 113′. The image beam 113′ is projected to a screen (not shown) by the projection lens 130 to form image frames.

To achieve a full color display effect of the projection apparatus 100, the red light source 112r, the green light source 112g and the blue light source 112b are turned on and then turned off in sequence. In other words, at any time point, only one light source with one color is turned on, and the light sources with the other colors are turned off. By mixing colors in a time-sequential manner, a full color display effect is then achieved. However, since each of the light sources with one color is turned on for only one third of time, the utilization efficiency of the light source of the projection apparatus 100 is poor. Accordingly, brightness of the image frames projected by the projection apparatus 100 is not high.

### SUMMARY OF THE INVENTION

The present invention is directed to an illumination system having a relatively high utilization efficiency of light sources.

An embodiment of the present invention provides an illumination system capable of providing at least one light beam to a light valve. The illumination system includes at least one light source, a linearization beam shaper and an optical scanning device. The light source is capable of providing the light beam. The linearization beam shaper is disposed on a transmission path of the light beam and between the light source and the light valve to expand the light beam along a first direction. The optical scanning device is disposed on the transmission path of the light beam and between the linearization beam shaper and the light valve. The optical scanning device is capable of moving for making the light beam scan the light valve unidirectionally along a second direction or back and forth along the second direction.

In the illumination system, since a light spot formed by the light beam incident on the linearization beam shaper is changed from a circular light spot to a linear uniform light spot, and since the light beam scans the light valve with the linear light spot by the optical scanning device, the light source may be in the on state continuously, which is different from a conventional technique which requires the light sources being constantly turned on and then turned off. Therefore, the illumination system has a relative high utilization efficiency of light sources.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a structural diagram of a conventional projection apparatus.

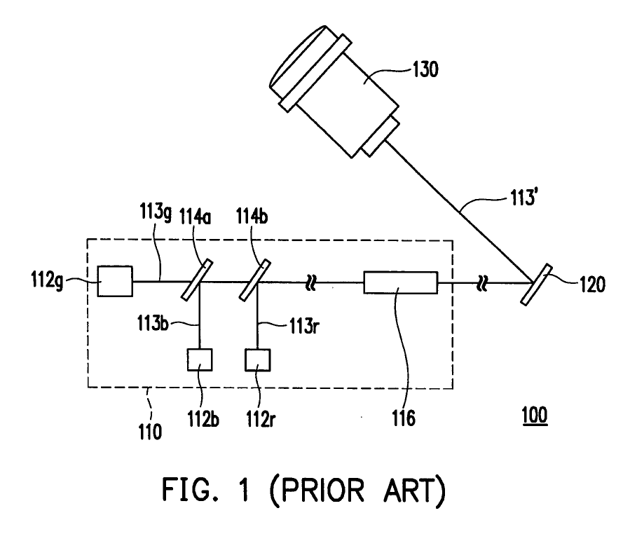

FIG. 2 is a structural diagram of an illumination system according to an embodiment of the present invention.

FIG. 3 is a structural diagram of an illumination system according to another embodiment of the present invention.

FIG. 4 is a structural diagram of an illumination system according to still another embodiment of the present invention.

FIG. 5 is a structural diagram of an illumination system according to still another embodiment of the present invention.

FIG. 6 is a structural diagram of an illumination system according to still another embodiment of the present invention.

FIG. 7 is a structural side view of an illumination system according still another embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

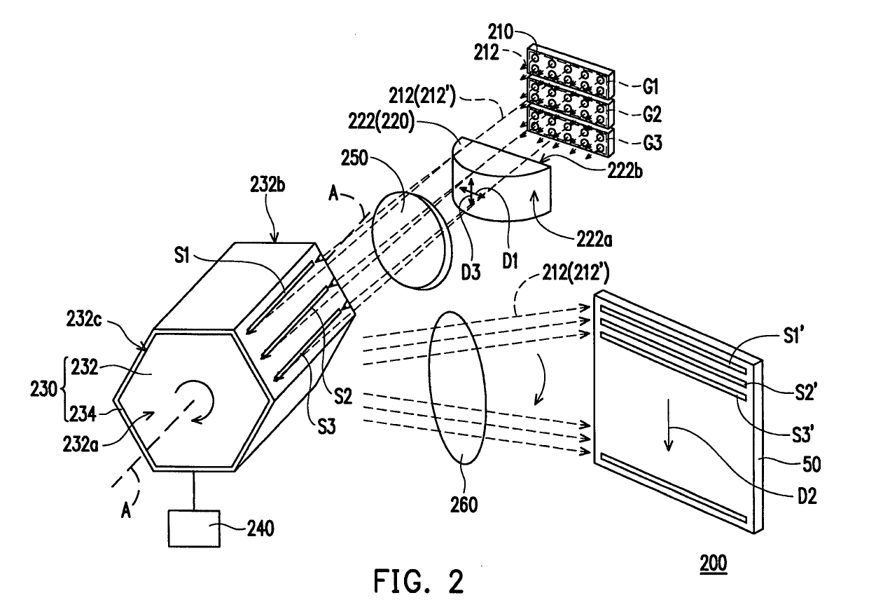

Referring to FIG. 2, an illumination system 200 according to an embodiment of the present invention is capable of providing a plurality of light beams 212 to a light valve 50. The illumination system 200 may be applied to a projection apparatus (not shown), and the light valve 50 may be a liquid-crystal-on-silicon (LCOS) panel, a digital micro-mirror device (DMD), a transmissive liquid crystal panel or other suitable light valves. The illumination system 200 includes a plurality of light sources 210, a linearization beam shaper 220 and an optical scanning device 230. The light sources 210 are capable of providing light beams 212. In the present embodiment, the light sources 210 may be lasers, light-emitting diodes (LEDs) or other suitable light sources. Moreover, the light sources 210 may be divided into a plurality of light-emitting groups, for example, a light-emitting group G1, a light-emitting group G2 and a light-emitting group G3. Each of the light-emitting groups is capable of providing an illumination beam 212′. Each of the light-emitting groups includes a plurality of light sources 210, the light beams 212 provided by which are combined to form the illumination beams 212′. Moreover, the illumination beams 212′ provided by different light-emitting groups have different colors. In the present embodiment, the light sources 210 of each of the light-emitting groups G1, G2 and G3 are arranged in an array. In addition, the light-emitting groups G1, G2 and G3 are arranged along a third direction D3.

The linearization beam shaper 220 is disposed on transmission paths of the light beams 212 and between the light sources 210 and the light valve 50 to expand the light beams 212 along a first direction D1, in which the third direction D3 is perpendicular to the first direction D1. The optical scanning device 230 is disposed on the transmission paths of the light beams 212 and between the linearization beam shaper 220 and the light valve 50. In the present embodiment, the linearization beam shaper 220 includes a lenticular lens 222. The lenticular lens 222 has a curve surface 222a facing to the optical scanning device 230. A cutaway section line of the curve surface 222a along the first direction D1 is a curve line, and the cutaway section line of the curve surface 222a along the third direction D3 perpendicular to the first direction D1 is a straight line. In other words, the curve surface 222a is only curved in one direction, and therefore the light beams 212 may be expanded along the first direction D1, namely, a cross-section view of the light beams 212 are straight lines. Moreover, in the present embodiment, the lenticular lens 222 further has a plane surface 222b facing to the light sources 210. In other embodiments, the curve surface may face to the light sources 210, or the lenticular lens 222 may have two curve surfaces respectively facing to the light sources 210 and the optical scanning device 230.

In the present embodiment, the optical scanning device 230 includes a polyhedron 232 and a reflection film 234. The polyhedron 232 is, for example, prismatical and has a bottom surface 232a, a top surface 232b and a plurality of side surfaces 232c connecting the bottom surface 232a with the top surface 232b. The reflection film 234 is disposed on the side surfaces 232c of the polyhedron 232 for reflecting the light beams 212 from the linearization beam shaper 220 to the light valve 50. Since the light-emitting groups G1, G2 and G3 are arranged along the third direction D3, and since, after passing through the linearization beam shaper 220, the cross-sectional view of the light beams 212 and the illumination beams 212′ are straight lines, the illumination beams 212′ form three paratactic linear light spots S1, S2 and S3 on the reflection film 234 respectively corresponding to the light-emitting groups G1, G2 and G3. Moreover, after being reflected by the reflection film 234, the illumination beams 212′ form three paratactic linear light spots S1′, S2′ and S3′ on the light valve respectively corresponding to the linear light spots S1, S2 and S3. In other embodiments, the light sources of each of the light-emitting groups may also be arranged along a straight line, for example, the first direction D1, so as to narrow the linear light spots formed on the reflection film to obtain a better image quality.

The optical scanning device 230 is capable of moving for making the light beams 212 and the illumination beams 212′ scan the light valve 50 unidirectionally along a second direction D2. In the present embodiment, the polyhedron 232 has an axis A extending from the bottom surface 232a to the top surface 232b, and the polyhedron 232 is capable of rotating about the axis A, such that the light beam 212 scans the light valve unidirectionally along the second direction D2. In other words, the linear light spots S1′, S2′ and S3′ scan the light valve 50 along the second direction D2 due to rotation of the polyhedron 232. In the present embodiment, the illumination beams 212′ emitted from the light-emitting groups G1, G2 and G3 are, for example, a red light, a green light and a blue light, and therefore the linear light spots S1′, S2′ and S3′ scanning on the light valve 50 are a red light spot, a green light spot and a blue light spot. Thus, based on a visual persistence effect of human eyes, the light valve 50 provides a full color image. In the present embodiment, the illumination system 200 further includes an actuator 240 connected with the optical scanning device 230 for driving the optical scanning device 230 to move around. In particular, the actuator 240 is, for example, a motor for driving the optical scanning device 230 to rotate.

To achieve a better effect for converging the light beams 212 on the reflection film 234, at least one lens 250 is disposed on the transmission paths of the light beams 212 and between the linearization beam shaper 220 and the optical scanning device 230. Moreover, to achieve a better quality of imaging formed by the light beams 212 on the light valve 50, at least one lens 260 is disposed on the transmission paths of the light beams 212 and between the optical scanning device 230 and the light valve 50.

In the illumination system 200 according to the present embodiment, since the light spots formed by the light beams 212 incident on the linearization beam shaper 220 are changed from circular light spots to linear uniform light spots, and since the light beams 212 scan the light valve 50 with the linear light spots S1′, S2′ and S3′ by the optical scanning device 230, the light sources 210 may be in an on state continuously, which is different from a conventional technique which requires the light sources being constantly turned on and then turned off. Therefore, the illumination system 200 has a relative high utilization efficiency of the light sources 210, such that extra energy consumption is saved, and brightness of the image frames projected by the projection apparatus is improved. Moreover, the price of the lenticular lens 222 is relatively low, and therefore the illumination system 200 not only improves its utilization efficiency of the light sources 210 but also has a low cost.

It should be noted that the quantity of the light sources for the illumination system is not limited by the present invention. In other embodiments, the illumination system may have only one light source, or the illumination system may have a plurality of light sources divided into a plurality of light-emitting groups, each of which has only one light source.

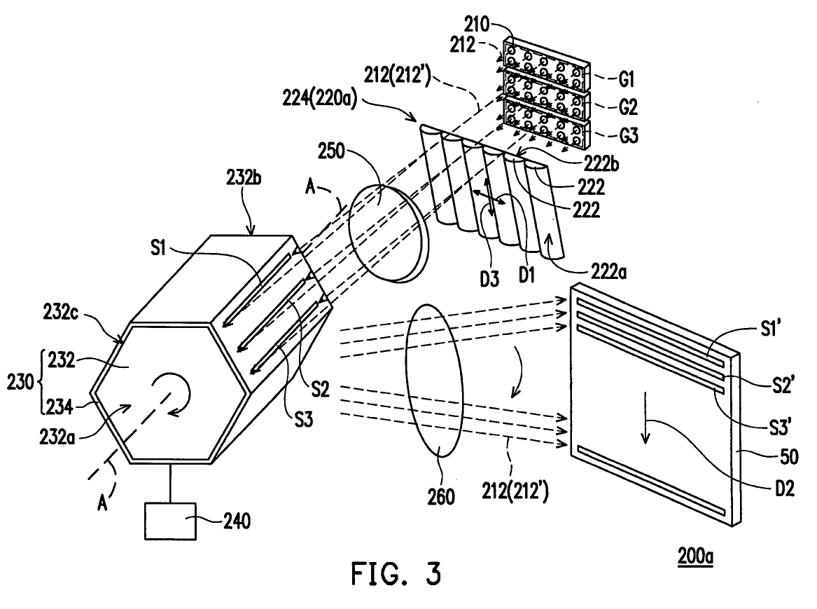

Referring to FIG. 3, an illumination system 200a according to another embodiment of the present invention is similar to the illumination system 200 in FIG. 2, and the differences therebetween are as follows. In the illumination system 200a, the linearization beam shaper 220a includes a plurality of lenticular lenses 222. The lenticular lenses 222 are arranged along the first direction D1 and integrated to form a lenticular lens plate 224, so as to obtain a better expanding effect of the light beams 212 along the first direction D1. Moreover, to reduce the cost, the lenticular lens plate 224 applied to the illumination system 200a may be a lenticular lens plate with a standard specification.

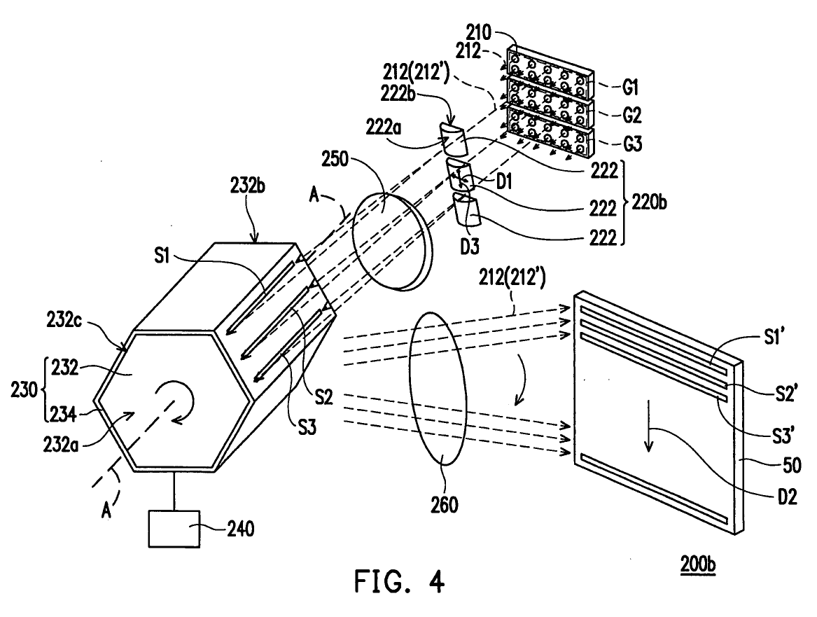

Referring to FIG. 4, an illumination system 200b according to still another embodiment of the present invention is similar to the illumination system 200 in FIG. 2, and the differences therebetween are as follows. In the illumination system 200b, the linearization beam shaper 220b includes a plurality of lenticular lenses 222 respectively disposed on the transmission paths of the illumination beams 212′ emitted from the light-emitting groups (such as the light-emitting groups G1, G2 and G3). In other words, the lenticular lenses 222 are arranged along the third direction D3. In other embodiments, the linearization beam shaper may also include a plurality of the aforementioned lenticular lens plates 224 (referring to FIG. 3) respectively disposed on the transmission paths of the illumination beams sent from the light-emitting groups, namely, the lenticular lens plates 224 are arranged along the third direction D3.

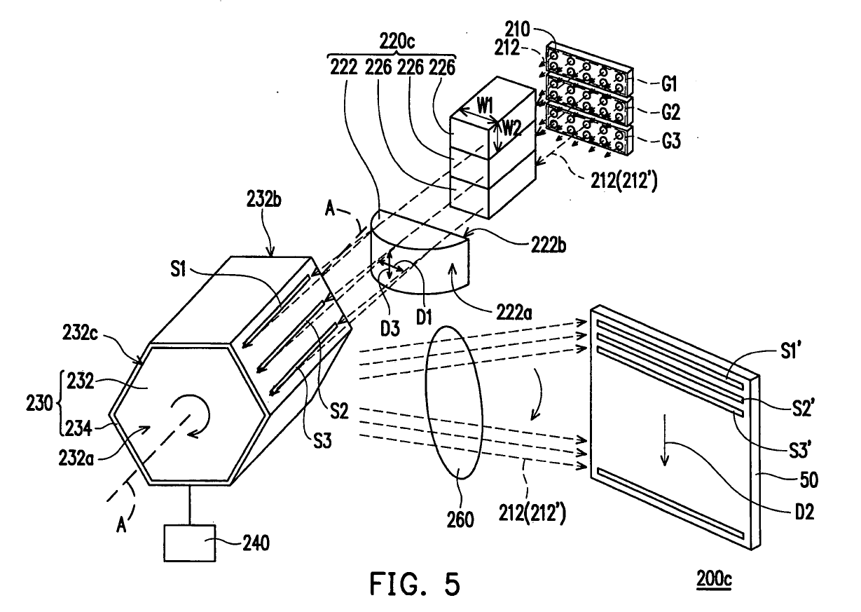

Referring to FIG. 5, an illumination system 200c according to still another embodiment of the present invention is similar to the illumination system 200 of FIG. 2, and the differences there between are as follows. In the illumination system 200c, the linearization beam shaper 220c further includes a plurality of light integration rods 226 respectively disposed on the transmission paths of the illumination beams 212′ emitted from the light-emitting groups (such as the light-emitting groups G1, G2 and G3) between the light sources 210 and the lenticular lens 222. The lenticular lens 222 is disposed on the transmission paths of the illumination beams 212′ and between the light integration rods 226 and the optical scanning device 230. In the present embodiment, a width W1 of each of the light integration rods 226 in the first direction D1 is greater than a width W2 of each light integration rod 226 in the third direction D3, such that the cross-sectional view of the light beams 212 passing through the integration rods 226 is a straight line, and therefore, when the light beams 212 passing through the lenticular lens 222 reach the reflection film 234, the linear light spots with better image quality is formed. Moreover, in the present embodiment, the light integration rods 226 are disposed along the third direction D3. In addition, the cost of the lenticular lenses 222 and the light integration rods 226 are relatively low, and therefore the illumination system 200 not only improves its utilization efficiency of the light source 210 but also has a low cost.

It should be noted that, in other embodiments, the aforementioned lenticular lens plate 224 (referring to FIG. 3) is used to substitute the lenticular lens 222 in the illumination system 200c, or a plurality of the aforementioned lenticular lenses 222 (referring to FIG. 4) arranged along the third direction D3 are used to substitute the lenticular lens 222 in the illumination system 200c, or a plurality of the aforementioned lenticular lens plates 224 (referring to FIG. 3) arranged along the third direction D3 are used to substitute the lenticular lens 222 in the illumination system 200c. Moreover, the quantity of the light integration rods is not limited by the present invention. In other embodiments, the illumination system may also have only one light integration rod 226.

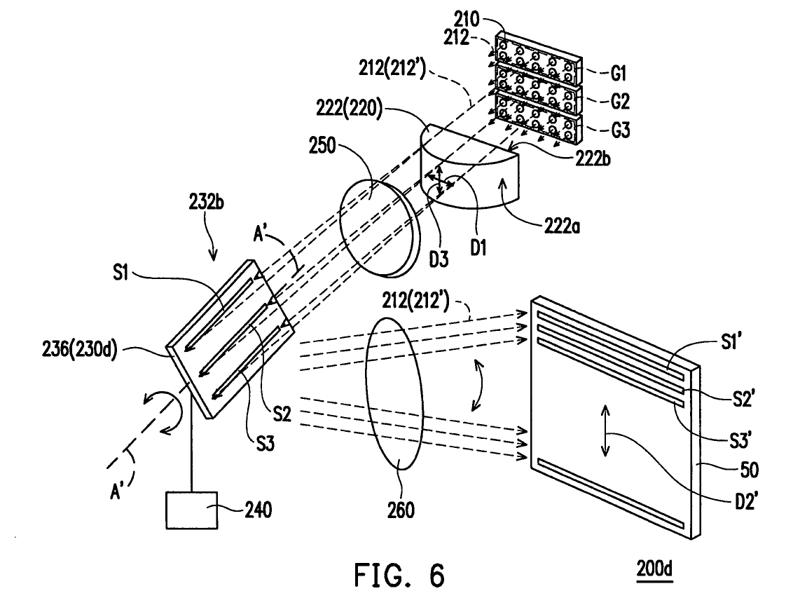

Referring to FIG. 6, an illumination system 200d according to still another embodiment of the present invention is similar to the illumination system 200 in FIG. 2, and the differences therebetween are as follows. In the illumination system 200d, the optical scanning device 230d is capable of moving for making the light beams 212 scan the light valve 50 back and forth along a second direction D2′. In particular, in the present embodiment, the optical scanning device 230d includes a reflection mirror 236 for reflecting the light beams 212 from the linearization beam shaper 220 to the light valve 50. The reflection mirror 236 has an axis A′, and the reflection mirror 236 is capable of swinging about the axis A′ for making the light beams 212 scan the light valve 50 back and forth along the second direction D2′. The actuator 240d may be a motor capable of driving the reflection mirror 236 to swing or other appropriate actuators.

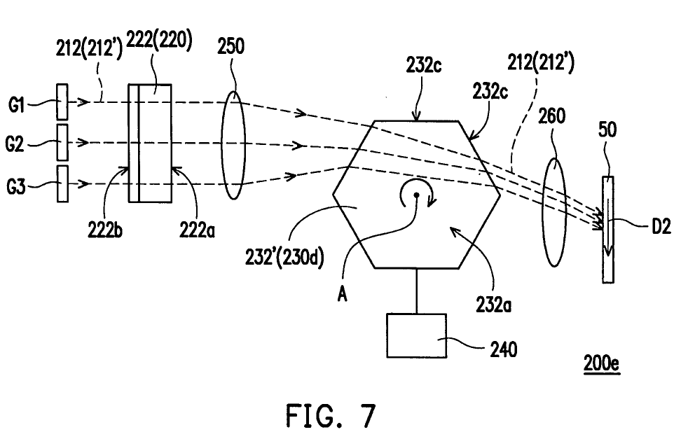

FIG. 7 is a structural side view of an illumination system according another embodiment of the present invention. Referring to FIG. 7, the illumination system 200e is similar to the illumination system 200 in FIG. 2, and the differences therebetween are as follows. In the illumination system 200e, the optical scanning device 230d includes a prism 232′ which is, for example, prismatical and has a shape similar to the polyhedron 232. However, the aforementioned reflection film 234 (referring to FIG. 2) is not included in the optical scanning device 230d. The prism 232′ is capable of swinging along the axis A for making the light beams 212 from the linearization beam shaper 220 enter the prism 232′ through one of the side surfaces 232c and exit the prism 232′ through another one of the side surfaces 232c to reach the light valve 50, so that the light beams 212 scan the light valve 50 unidirectionally along the second direction D2.

In summary, in the illumination system, since the light spot formed by the light beam incident on the linearization beam shaper is changed from a circular light spot to a linear uniform light spot, and since the light beam scans the light valve with the linear light spot by the optical scanning device, the light source may be in an on state continuously, which is different from a conventional technique which requires the light sources being constantly turned on and then turned off. Therefore, the illumination system of the embodiments of the present invention has a relative high utilization efficiency of the light source. Accordingly, extra energy consumption is reduced, and brightness of the image frames projected by the projection apparatus using the aforementioned illumination system is improved. Moreover, low cost accessories such as the lenticular lens, the lenticular plate and the light integration rod may be adopted, and therefore the illumination system of the embodiments of the present invention not only improves its utilization efficiency of the light sources but also has a low cost.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, for providing at least one light beam to a light valve, comprising:
at least one light source, for providing the light beam;
a linearization beam shaper, disposed on a transmission path of the light beam and between the light source and the light valve to expand the light beam along a first direction; and
an optical scanning device, disposed on the transmission path of the light beam and between the linearization beam shaper and the light valve, wherein the optical scanning device is capable of moving for making the light beam scan the light valve unidirectionally along a second direction or back and forth along the second direction.

2. The illumination system as claimed in claim 1, wherein the linearization beam shaper comprises at least one lenticular lens having at least one curve surface facing to the light source or the optical scanning device, a cutaway section line of the curve surface along the first direction is a curve line, and a cutaway section line of the curve surface along a third direction perpendicular to the first direction is a straight line.

3. The illumination system as claimed in claim 2, wherein the at least one lenticular lens comprises a plurality of the lenticular lenses arranged along the first direction and integrated to form a lenticular lens plate.

4. The illumination system as claimed in claim 2, wherein the linearization beam shaper further comprises at least one light integration rod disposed on the transmission path of the light beam and between the light source and the lenticular lens, and a width of the light integration rod in the first direction is greater than a width of the light integration rod in the third direction.

5. The illumination system as claimed in claim 1, wherein the at least one light source comprises a plurality of the light sources, the light sources are divided into a plurality of light-emitting groups, each of the light-emitting groups is capable of providing an illumination beam, and the illumination beams provided by different light-emitting groups have different colors.

6. The illumination system as claimed in claim 5, wherein each of the light-emitting groups comprises a plurality of light sources arranged in an array.

7. The illumination system as claimed in claim 5, wherein the light-emitting groups are arranged along a third direction perpendicular to the first direction.

8. The illumination system as claimed in claim 5, wherein the linearization beam shaper comprises a plurality of the lenticular lenses, each of the lenticular lenses has at least one curve surface facing to the light sources or the optical scanning device, a cutaway section line of the curve surface along the first direction is a curve line, and a cutaway section line of the curve surface along a third direction perpendicular to the first direction is a straight line, and the lenticular lenses are respectively disposed on transmission paths of the illumination beams provided by the light-emitting groups.

9. The illumination system as claimed in claim 5, wherein the linearization beam shaper comprises a plurality of lenticular lens plates, each of the lenticular lens plates has a plurality of the lenticular lenses arranged along the first direction, each of the lenticular lens has at least one curve surface facing to the light sources or the optical scanning device, a cutaway section line of the curve surface along the first direction is a curve line, a cutaway section line of the curve surface along a third direction perpendicular to the first direction is a straight line, and the lenticular lenses are respectively disposed on transmission paths of the illumination beams provided by the light-emitting groups.

10. The illumination system as claimed in claim 5, wherein the linearization beam shaper comprises:
a plurality of light integration rods, respectively disposed on transmission paths of the illumination beams provided by the light-emitting groups; and
at least one lenticular lens, disposed on the transmission paths of the illumination beams and between the light integration rods and the optical scanning device, wherein the lenticular lens has at least one curve surface facing to the light integration rods or the optical scanning device, a cutaway section line of the curve surface along the first direction is a curve line, and a cutaway section line of the curve surface along a third direction perpendicular to the first direction is a straight line.

11. The illumination system as claimed in claim 10, wherein the at least one lenticular lens comprises a plurality of lenticular lenses arranged along the first direction and integrated to form a lenticular lens plate.

12. The illumination system as claimed in claim 10, wherein the light integration rods are arranged along the third direction.

13. The illumination system as claimed in claim 10, wherein a width of each of the light integration rods in the first direction is greater than a width of each of the light integration rods in the third direction.

14. The illumination system as claimed in claim 1, wherein the optical scanning device comprises:
a polyhedron, having a bottom surface, a top surface and a plurality of side surfaces connecting the bottom surface with the top surface; and
a reflection film, disposed on the side surfaces of the polyhedron, for reflecting the light beam from the linearization beam shaper to the light valve, wherein the polyhedron has an axis extending from the bottom surface to the top surface, and the polyhedron is capable of rotating about the axis for making the light beam scan the light valve unidirectionally along the second direction.

15. The illumination system as claimed in claim 1, wherein the optical scanning device comprises a prismatical prism having a bottom surface, a top surface and a plurality of side surfaces connecting the bottom surface with the top surface, the prismatical prism has an axis extending from the bottom surface to the top surface, the prismatical prism is capable of rotating about the axis for making the light beam from the linearization beam shaper enter the prism through one of the side surfaces and exit the prism through another one of the side surfaces to reach the light valve, whereby the light beam scans the light valve unidirectionally along the second direction.

16. The illumination system as claimed in claim 1, wherein the optical scanning device comprises a reflection mirror for reflecting the light beam from the linearization beam shaper to the light valve, the reflection mirror has an axis, and the reflection mirror is capable of swinging about the axis for making the light beam scan the light valve back and forth along the second direction.

17. The illumination system as claimed in claim 1, wherein the light source is a laser or a light-emitting diode.

18. The illumination system as claimed in claim 1, further comprising an actuator connected to the optical scanning device for driving the optical scanning device to move.

19. The illumination system as claimed in claim 1, further comprising at least one lens disposed on the transmission path of the light beam and between the linearization beam shaper and the optical scanning device.

20. The illumination system as claimed in claim 1, further comprising at least one lens disposed on the transmission path of the light beam and between the optical scanning device and the light valve.
